(19) United States
(12) Patent Application Publication
(10) Pub. No.: US 2025/0141167 A1
(43) Pub. Date: May 1, 2025

(54) ELECTRICAL CONNECTION DEVICE

(71) Applicant: MOLEX, LLC, Lisle, IL (US)

(72) Inventors: Yi-Tse Ho, New Taipei City (TW); Timothy R. Gregori, New Lenox, IL (US)

(21) Appl. No.: 18/912,634

(22) Filed: Oct. 11, 2024

(30) Foreign Application Priority Data
Nov. 1, 2023 (CN) 202311445426.3
Apr. 26, 2024 (CN) 202410513522.5

(51) Int. Cl. H01R 25/16; H01R 12/91; H01R 13/11; H01R 13/42; H01R 13/631; H01R 13/684; H02B 1/20

(52) U.S. Cl. CPC H01R 25/165; H01R 12/91; H01R 13/111; H01R 13/42; H01R 13/6315; H01R 13/684; H01R 25/167; H02B 1/207

(57) ABSTRACT

An electrical connection device includes a busbar assembly and a connecting assembly, the busbar assembly includes a first busbar and a second busbar which are insulated from each other. The connecting assembly includes two first plugs and two second plugs, the two first plugs are spaced apart from each other along a length direction of the first busbar, are provided to the first busbar, and are respectively toward opposite directions, the two second plugs are spaced apart from each other along a length direction of the second busbar, are provided to the second busbar, and are respectively toward opposite directions.

### TECHNICAL FIELD

The present disclosure relates to an electrical connection device, and particularly relates to an electrical connection device for busbar.

### BACKGROUND

In technology disclosed in Chinese patent document CN109426326A, one end of a first linking busbar and one end of a second linking busbar are electrically connected with a power distribution shelf respectively via clip-type electrical connectors, the other end of the first linking busbar and the other end of the second linking busbar are connected to a rack busbar respectively via a first output part and a second output part which bend and extend respectively relative to a first busbar main body and a second busbar main body, so as to realize electrical connection with the rack busbar, it is more complex in structure.

Moreover, due to limitation on space use of a server rack, such a busbar structure design occupies more space.

### SUMMARY

Therefore, an object of the present disclosure is to provide an electrical connection device which is simpler in structure.

Another object of the present disclosure is to provide an electrical connection device which may save space.

Accordingly, an electrical connection device of the present disclosure comprises a busbar assembly and a connecting assembly, the busbar assembly comprises a first busbar and a second busbar which are insulated from each other, the connecting assembly comprises two first plugs and two second plugs, the two first plugs are spaced apart from each other along a length direction of the first busbar, are provided to the first busbar, and are respectively toward opposite directions, the two second plugs are spaced apart from each other along a length direction of the second busbar, are provided to the second busbar, and are respectively toward opposite directions.

In some embodiments, the first busbar and the second busbar overlap with each other, and two ends of the first busbar respectively extend beyond two ends of the second busbar.

In some embodiments, the first busbar and the second busbar overlap with each other, and one end of any one of the first busbar and the second busbar extends beyond one end of the other of the first busbar and the second busbar.

In some embodiments, the second busbar comprises a first plate and a second plate which are spaced apart from each other and a fuse assembly which is provided between the first plate and the second plate.

In some embodiments, an end portion of the first plate and an end portion of the second plate are spaced apart from each other and face each other, the fuse assembly comprises a fuse body and two locking pieces which protrude from two sides of the fuse body, the two locking pieces are respectively locked to the end portions of the first plate and the second plate which face each other.

In some embodiments, the end portions of the first plate and the second plate which face each other bend to be spaced apart from the first busbar.

In some embodiments, one of the two second plugs which are provided to the second busbar passes through the first busbar.

In some embodiments, the first busbar is provided with a through hole which allows the one of the two second plugs to pass through, and a diameter of the through hole is larger than the one of the two second plugs so that the one of the two second plugs does not contact the first busbar when the one of the two second plugs passes through the through hole.

In some embodiments, an inner edge of the through hole is provided with an insulative layer which prevents the one of the two second plugs from contacting and being electrically connected with the first busbar.

In some embodiments, the first busbar and the second busbar are provided therebetween with an insulative layer to be insulated from each other.

In some embodiments, the electrical connection device further comprises a mating busbar assembly, the mating busbar assembly comprises a third busbar and a fourth busbar, and the connecting assembly further comprises a plurality of first receptacles which are provided to the third busbar and the fourth busbar, the plurality of first receptacles allow some of the two first plugs and the two second plug to mate therewith in a pluggable and floatable manner so that the busbar assembly and the mating busbar assembly are electrically connected with each other.

In some embodiments, when the busbar assembly and the mating busbar assembly are electrically connected with each other, a length direction of the busbar assembly and a length direction of the mating busbar assembly have an angle therebetween.

In some embodiments, the busbar assembly is provided in a transverse direction, the mating busbar assembly is provided in a longitudinal direction.

In some embodiments, the third busbar and the fourth busbar are flat-plate shaped and are provided to be arranged side by side with a plate edge of the third busbar and a plate edge of the fourth busbar facing each other.

In some embodiments, the electrical connection device further comprises a circuit board which is provided in a horizontal direction, and the connecting assembly further comprises a plurality of second receptacles which are provided to the circuit board, the plurality of second receptacles respectively allow some of the two first plugs and the two second plugs to mate therewith in a pluggable and floatable manner so that the busbar assembly and the circuit board are electrically connected with each other.

In some embodiments, the circuit board comprises a board body and conductive seats which are provided to the board body, the conductive seats are uprightly provided relative to the board body, the plurality of second receptacles are provided to the conductive seats, respectively.

In some embodiments, the first busbar and the second busbar are flat-plate shaped.

In some embodiments, each first plug has a mounting portion which is provided to the first busbar and a contact portion which protrudes from the mounting portion and is in form of post, the contact portions of the two first plugs are toward the opposite directions respectively; each second plug has a mounting portion which is provided to the second busbar and a contact portion which protrudes from the mounting portion and is in form of post, the contact portions of the two second plugs are toward the opposite directions respectively.

In some embodiments, the electrical connection device further comprises: a mating busbar assembly which comprises a third busbar and a fourth busbar, and the connecting assembly further comprises a plurality of first receptacles which are provided to the third busbar and the fourth busbar, the plurality of first receptacles allow some of the two first plugs and the two second plug to mate therewith in a pluggable and floatable manner so that the busbar assembly and the mating busbar assembly are electrically connected with each other; and a circuit board which is provided in a horizontal direction, and the connecting assembly further comprises a plurality of second receptacles which are provided to the circuit board, the plurality of first receptacles and the plurality of second receptacles respectively allow the two first plugs, which are respectively toward the opposite directions, and the two second plugs, which are respectively toward the opposite directions, to mate therewith in a pluggable and floatable manner so that the mating busbar assembly and the circuit board are electrically connected with each other via the busbar assembly.

In some embodiments, when the two first plugs and the two second plugs mate with the plurality of first receptacles and the plurality of second receptacles, the two first plugs and the two second plugs are capable of floating relative to the plurality of first receptacles and the plurality of second receptacles along an inserting direction and a radial direction perpendicular to the inserting direction.

In some embodiments, the first receptacle and the second receptacle each comprise a base, a barrel-shaped member, a pressure applying member and a contacting member; the base has a passageway which extends between two ends of the base and an annular receiving groove which extends outwardly from the passageway, the barrel-shaped member has a barrel body whose outer diameter is less than the passageway and an annular flange which extends outwardly from an outer wall surface of the barrel body, the annular flange is movably received in the annular receiving groove, the pressure applying member has elasticity and is provided between the annular flange of the barrel-shaped member and the annular receiving groove to allow the barrel-shaped member to be floatable in the passageway along the inserting direction, the contacting member is provided in the barrel body of the barrel-shaped member; the first plug and the second plug each have a contact portion, the contact portion inserts into the corresponding one of the first receptacle and the second receptacle along the inserting direction and contacts the contacting member, and is capable of floating relative to the contacting member along the radial direction.

In the present disclosure, by employing the plurality of first plugs opposite in direction and the plurality of the second plug opposite in direction, a structure that the busbar assembly is electrically connected with the mating busbar assembly and the circuit board respectively is simplified. Moreover, by that busbar assembly is provided as a flat-plate shaped structure, and in cooperation with provision of the mating busbar assembly, the first plugs and the second plugs and the first receptacles and the second receptacle, when the mating busbar assembly needs to be electrically connected with the circuit board via the busbar assembly, a distance between the mating busbar assembly and the circuit board may be shorten, in turn a space that the entire system needs to occupy is reduced.

### BRIEF DESCRIPTION OF THE DRAWINGS

Other features and effects of the present disclosure will become apparent in embodiments with reference to the drawings, in which:

FIG. 1 is a perspective view of a first embodiment of an electrical connection device of the present disclosure illustrating that the electrical connection device includes two busbar assemblies, a mating busbar assembly, a connecting assembly and a circuit board;

FIG. 2 is a partially exploded view of the first embodiment illustrating that the two busbar assemblies and the mating busbar assembly are separated from each other;

FIG. 3 and FIG. 4 are a perspective view and an exploded view of one of the two busbar assemblies of the first embodiment;

FIG. 5 and FIG. 6 are a perspective view and an exploded view of the other of the two busbar assemblies of the first embodiment;

FIG. 7 is a cross sectional view taken along a line VII-VII of FIG. 6 and illustrating a state that a contact portion of a second plug passes through a first busbar;

FIG. 8 is a cross sectional view taken along a line VIII-VIII of FIG. 1 and illustrating a state that one of second plugs mates with one of second receptacles;

FIG. 9 is a top view of the first embodiment;

FIG. 10 is a perspective view of a second embodiment of the electrical connection device of the present disclosure illustrating another implementing manner of second busbars of two busbar assemblies of the electrical connection device;

FIG. 11 and FIG. 12 are a perspective view of the second embodiment illustrating that the second busbar of one of the two busbar assemblies of the electrical connection device includes a first plate, a second plate and a fuse assembly provided between the first plate and the second plate; and

FIG. 13 and FIG. 14 are a perspective view and an exploded view of the second embodiment illustrating the second busbar of the other of the busbar assemblies of the electrical connection device includes a first plate, a second plate and a fuse assembly provided between the first plate and the second plate.

### DETAILED DESCRIPTION

Before the present disclosure is described in detail, it is noted that the similar elements are indicated by the same reference numerals in the following description.

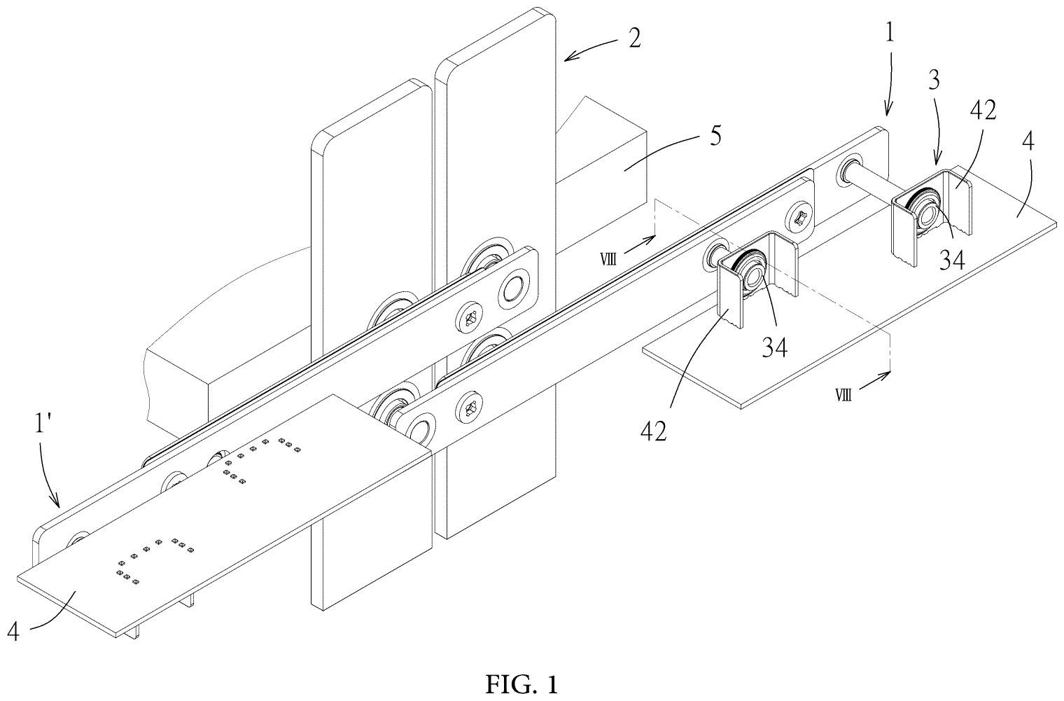

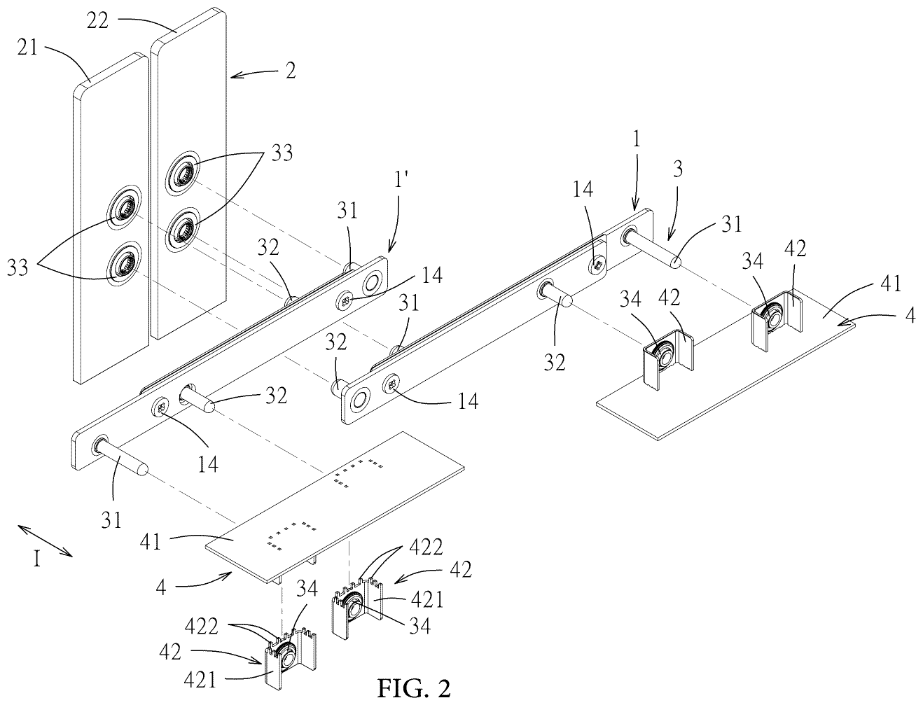

Referring to FIG. 1 and FIG. 2, a first embodiment of an electrical connection device of the present disclosure includes two busbar assemblies 1, 1′, a mating busbar assembly 2, a connecting assembly 3 and a circuit board 4, where the mating busbar assembly 2 may for example be provided to a server casing 5, and provide an electrical connection with the circuit board 4 via the busbar assemblies 1, l′ and the connecting assembly 3, for sake of convenient understanding, in the following description, a direction that the busbar assemblies 1, 1′ face the mating busbar assembly 2 is defined as front, a direction that the busbar assemblies 1, 1′ face the circuit board 4 is defined as rear. Moreover, in the following first embodiment, that the busbar assemblies 1, 1′in two different implementing manners cooperate the two circuit boards 4 are described, in other words, the mating busbar assembly 2 may cooperate with single busbar assembly 1, 1′, also may cooperate with the busbar assemblies 1, 1′, which are described as follows in detail.

Referring to FIG. 2 and FIG. 3 to FIG. 6, each busbar assembly 1, 1′ includes a first busbar 11, 11′ and a second busbar 12, 12′ which are insulated from each other and overlap with each other and a locking assembly 14. In the present embodiment, the first busbar 11, 11′ and the second busbar 12, 12′ are insulated from each other via an insulative layer 13 provided therebetween, specifically, the insulative layer 13 may be an insulative sheet, but in other varied implementing manners, the insulative layer 13 also may be realized as an insulative coating or an insulative adhesive, and the like. The locking assembly 14 includes a screw 141 and a nut 142 which are used to lock each other and clamp the first busbar 11, 11′, the second busbar 12, 12′ and the insulative layer 13 therebeween, the locking assembly 14 is an insulative material.

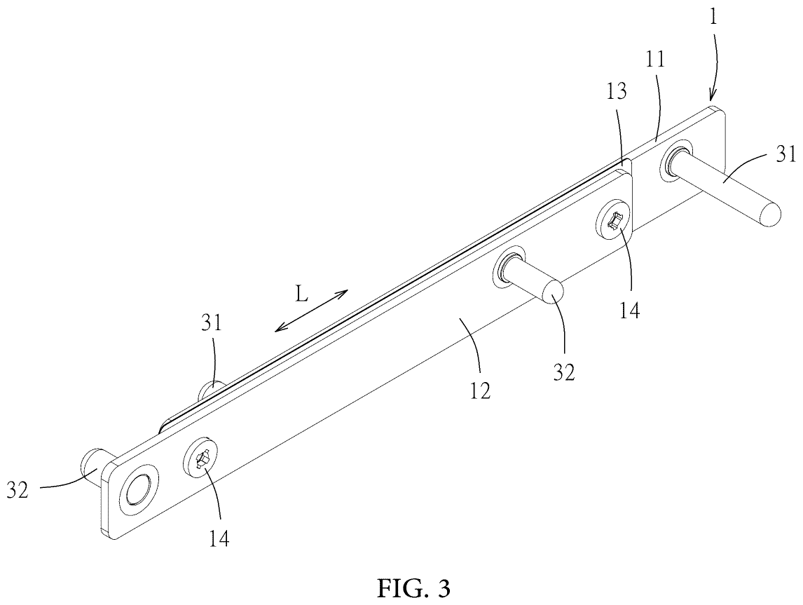

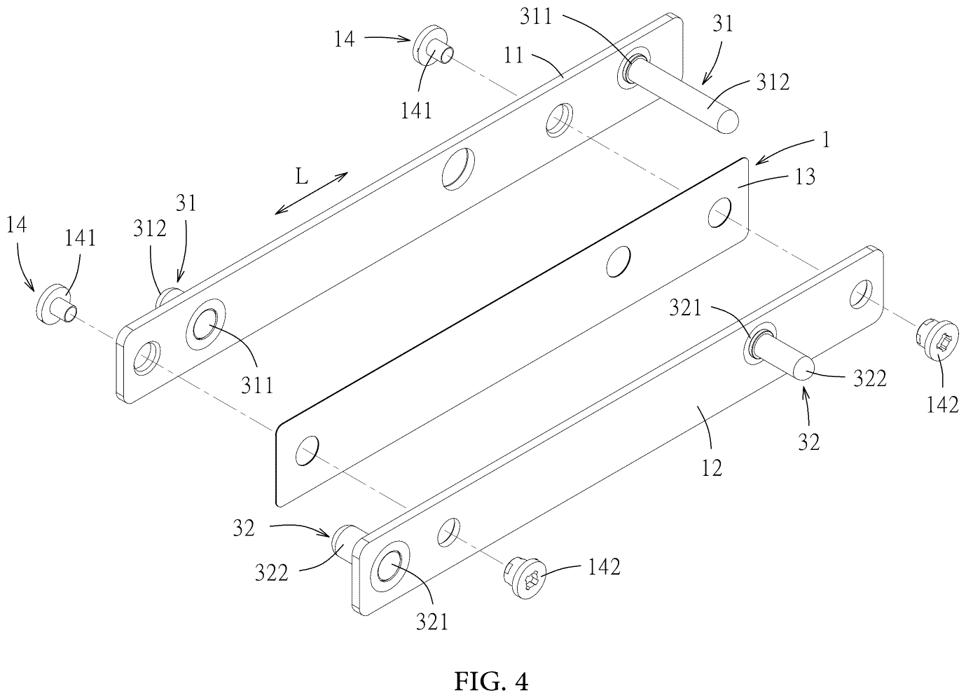

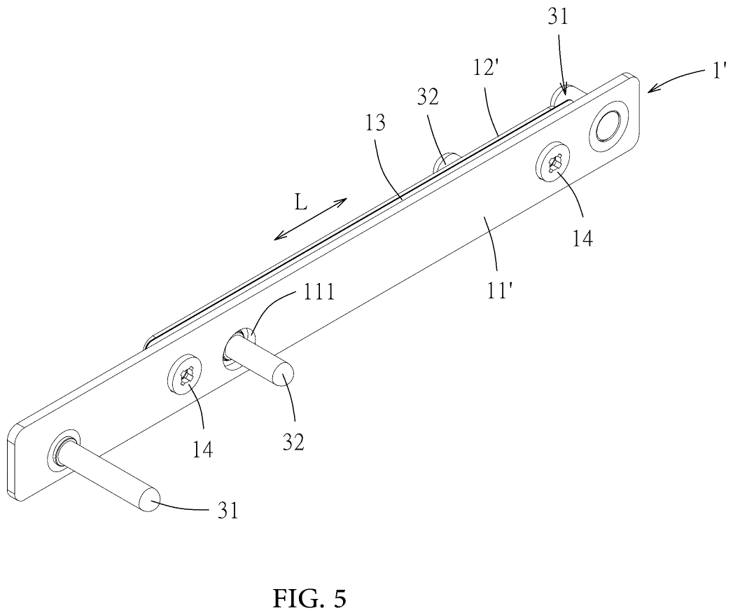

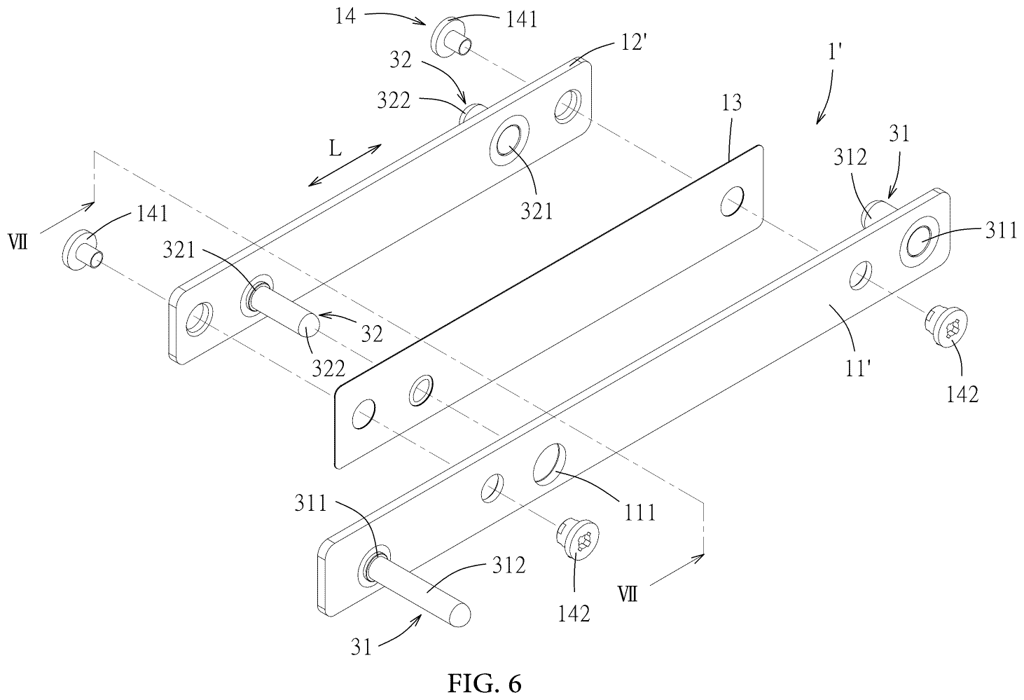

In the present embodiment, as shown in FIG. 3 and FIG. 4, when the first busbar 11 and the second busbar 12 of the busbar assembly 1 of the two busbar assemblies 1, 1′ overlap with each other, the first busbar 11 and the second busbar 12 are slightly staggered in a length direction L (also a left-right direction), so that one end of any one of the first busbar 11 and the second busbar 12 extends beyond one end of the other of the first busbar 11 and the second busbar 12, as shown in FIG. 5 and FIG. 6, a length of the first busbar 11′ of the busbar assembly l′ of the two busbar assemblies 1, 1′is larger than a length of the second busbar 12′, so when the first busbar 11′ and the second busbar 12′ of the busbar assembly 1′ overlap with each other, two ends of the first busbar 11′ respectively extend beyond two ends of the second busbar 12′.

The mating busbar assembly 2 includes a third busbar 21 and a fourth busbar 22. In the present embodiment, the third busbar 21 and the fourth busbar 22 are flat-plate shaped and are provided to the server casing 5 along a longitudinal direction, and are provided to be arranged side by side with a plate edge of one side of the third busbar 21 and a plate edge of one side of the fourth busbar 22 facing each other.

Referring to FIG. 2, FIG. 4, FIG. 6, the connecting assembly 3 includes a plurality of first plugs 31, a plurality of second plugs 32, and a plurality of first receptacles 33 and a plurality of second receptacles 34, the plurality of first receptacles 33 and the plurality of second receptacles 34 are respectively provided to the mating busbar assembly 2 and the circuit board 4, and the plurality of first receptacles 33 and the plurality of second receptacles 34 provide pluggable and floatable mating for the plurality of first plugs 31 and the plurality of second plugs 32. In the present embodiment, each first, second plug 31, 32 includes a mounting portion 311, 321 which is provided to respective first, second busbar 11, 12, 11′, 12′ and a contact portion 312, 322 which protrudes from the mounting portion 311, 321 and is in form of post, where the mounting portion 311, 321 is used to be fixed to respective first, second busbar 11, 12, 11′, 12′, the contact portion 312, 322 protrudes from the mounting portion 311, 321.

The number of the first plug 31 and the number of the second plug 32 provided to each busbar assembly 1, 1′ each are two, the two first plugs 31 are spaced apart from each other along the length direction L of the first busbar 11, 11′, are provided to the first busbar 11, 11′, and are respectively toward opposite directions, in other words, the contact portion 312 of one of the two first plugs 31 is toward the mating busbar assembly 2 which is positioned to the front, the contact portion 312 of the other of the two first plugs 31 is toward the circuit board 4 which is positioned to the rear, similarly, the two second plugs 32 are spaced apart from each other along the length direction L of the second busbar 12, 12′, are provided to the second busbar 12, 12′, and are respectively toward opposite directions, so the contact portion 322 of one of the two second plugs 32 is toward the mating busbar assembly 2 which is positioned to the front, the contact portion 322 of the other of the two second plugs 32 is toward the circuit board 4 which is positioned to the rear, in addition, in the busbar assembly 1, because one end of any one of the first busbar 11 and the second busbar 12 extends beyond one end of the other of the first busbar 11 and the second busbar 12, one of the two first plugs 31 and one of the two second plugs 32 are provided to segments where the one end of any one of the first busbar 11 and the second busbar 12 extends beyond one end of the other of the first busbar 11 and the second busbar 12, the other of the two first plugs 31 and the other of the two second plugs 32 are provided to segments where the first busbar 11 and the second busbar 12 overlap with each other and are opposite to the one of the two first plugs 31 and the one of the two second plugs 32 respectively.

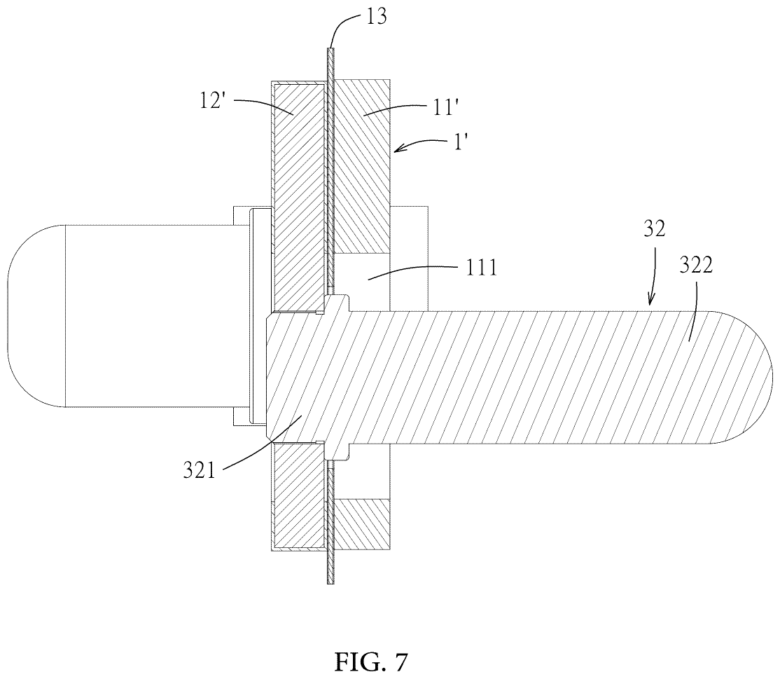

In the busbar assembly 1′, referring to FIG. 5 to FIG. 7, because the length of the second busbar 12′ is shorter, one of the two second plugs 32 must pass through the first busbar 11′, and because the first busbar 11′ and the second busbar 12′ are used to transmit different polar currents, in order to avoid causing short circuit, the first busbar 11′ is provided with a through hole 111 which allows the contact portion 322 of one of the two second plugs 32 positioned to the second busbar 12′ to pass through, and a diameter of the through hole 111 is larger than the one of the two second plugs 32 so that when the contact portion 322 of the one of the two second plugs 32 passes through the through hole 111, the contact portion 322 of the one of the two second plugs 32 does not contact the first busbar 11′. More beneficially, an inner edge of the through hole 111 also may be provided with an insulative layer (not shown) to avoid that the one of the two second plugs 32 contacting and being electrically connected with the first busbar 11′.

In the present embodiment, the circuit board 4 is provided in a horizontal direction and includes a board body 41 and conductive seats 42 provided to the board body 41, the conductive seats 42 are provided uprightly relative to the board body 41 and are electrically connected with the board body 41. The conductive seat 42 includes a seat body 421 whose cross section is U-shaped and a pin 422 which is provided to a bottom portion of the seat body 421, the conductive seat 42 inserts into the board body 41 via the pin 422 to form electrical connection with the board body 41.

The plurality of first receptacles 33 are respectively provided to the third busbar 21 and the fourth busbar 22 of the mating busbar assembly 2, are used to allow the first plugs 31 and the second plugs 32, which are toward the mating busbar assembly 2, to mate therewith, so that the busbar assemblies 1, 1′ and the mating busbar assembly 2 are electrically connected with each other, the plurality of the second receptacle 34 are provided to the conductive seats 42 of the circuit boards 4, are used to allow the first plugs 31 and the second plugs 32, which are toward the circuit boards 4, to mate therewith, therefore, the mating busbar assembly 2 is electrically connected with the circuit boards 4 via the busbar assemblies 1, 1′.

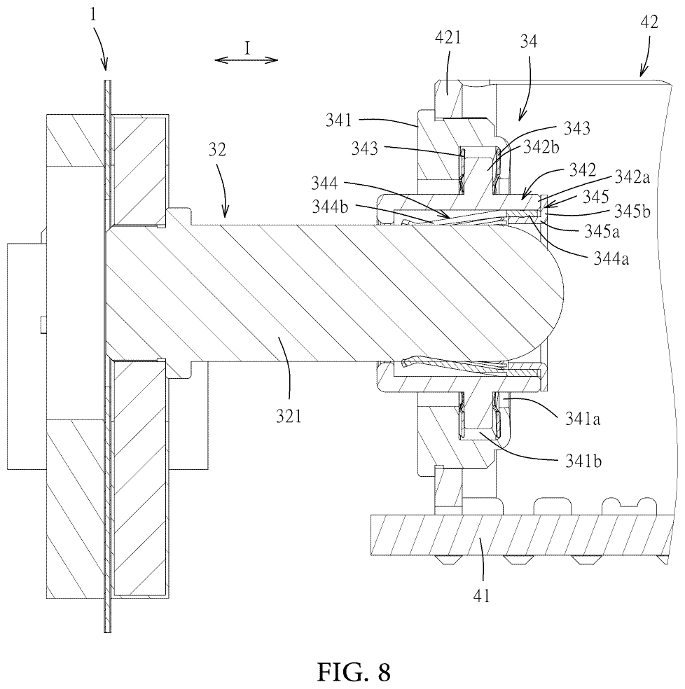

Referring to FIG. 1, FIG. 2 and FIG. 8, the third receptacle 33 and the fourth receptacle 34 are the same in structure, taking the fourth receptacle 34 of FIG. 8 as example for description, the first receptacle 33 and the second receptacle 34 each includes a base 341, a barrel-shaped member 342, two pressure applying members 343, a contacting member 344, and a fixing ring 345. The first receptacle 33 is fixed to the third, fourth busbar 21, 22 via the base 341 of the first receptacle 33, the second receptacle 34 is fixed to the seat body 421 of the conductive seat 42 via the base 341 of the second receptacle 34.

The contact portion 312, 322 of the first, second plug 31, 32 is used to insert into the barrel-shaped member 342 of the first, second receptacle 33, 34 along an inserting direction I (i.e. a front-rear direction) and contact the contacting member 344 (FIG. 8 only illustrates a state that one second plug 32 of the first busbar assembly 1 inserts into the fourth receptacle 34 as example for description). The base 341 has a passageway 341a which extends between two ends of the base 341 and an annular receiving groove 341b which extends outwardly from the passageway 341a. The barrel-shaped member 342 has a barrel body 342a whose outer diameter is less than the passageway 341a and an annular flange 342b which extends outwardly from an outer wall surface of the barrel body 342a, the annular flange 342b is movably received in the annular receiving groove 341b. The two pressure applying members 343 have elasticity and are provided between the annular flange 342b of the barrel-shaped member 342 and the annular receiving groove 341b to allow the barrel-shaped member 342 to be floatable in the passageway 341a. Specifically, in the present embodiment, the two pressure applying members 343 are waveform spring ring pieces and are respectively provided to two end surfaces of the annular flange 342b in the inserting direction I, to make the barrel-shaped member 342 be capable of floating in the passageway 341a in a radial direction perpendicular to the inserting direction I, but in other implementing manners, the pressure applying members 343 may be other existing elastic members which can be used to apply a pressure, and the number of the pressure applying member 343 may be one or three or more, and is not limited to that of the first embodiment.

The contacting member 344 is provided in the barrel body 342a of the barrel-shaped member 342 and allows the contact portion 312, 322 of the first, second plug 31, 32 to pass therethrough. The contacting member 344 has an annular head portion 344a which is provided to an inner wall surface of the barrel body 342a adjacent to one end edge of the barrel body 342a, and a plurality of elastic contacting pieces 344b which obliquely extend inwardly from the annular head portion 344a toward the other end edge of the barrel body 342a and are used to contact the contact portion 312, 322. The fixing ring 345 and the barrel body 342a of the barrel-shaped member 342 together clamp the annular head portion 344a of the contacting member 344 to fix the contacting member 344 in the barrel-shaped member 342. Specifically, the fixing ring 345 has a clamping portion 345a which is annular and clamps the annular head portion 344a of the contacting member 344 together with the inner wall surface of the barrel body 342a, and an abutting portion 345b which extends outwardly from an end edge of the clamping portion 345a and abuts against the end edge of the barrel body 342a. Specifically, because the contact portion 312, 322 of the first, second plug 31,32 inserts into and contacts the contacting member 344 along the inserting direction I, the contact portion 312, 322 of the first, second plug 31, 32 is capable of floating along the inserting direction I to float relative to the contacting member 344.

In the present embodiment, the mating busbar assembly 2 is provided longitudinally, but the busbar assemblies 1, 1′ are provided transversely, when the busbar assemblies 1, 1′ are electrically connected with the mating busbar assembly 2, the busbar assemblies 1, 1′are perpendicular to the direction of the mating busbar assembly 2, but in other implementing manners, the provided direction of the mating busbar assembly 2 and the provided direction of the busbar assemblies 1, 1′ also may intersect each other by an angle but may be not perpendicular to each other in length directions thereof depend on practical use circumstance and demand.

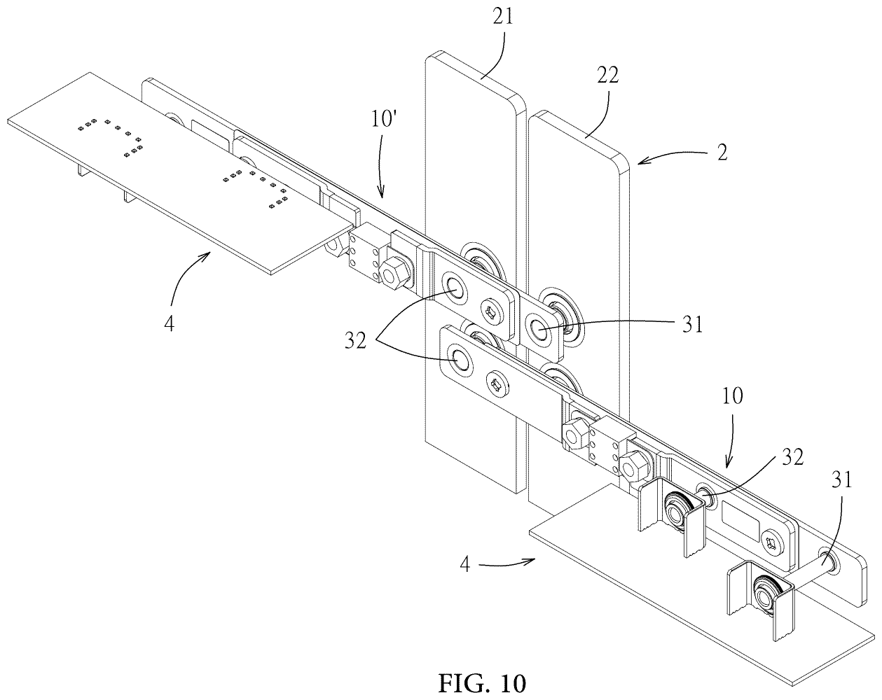

Referring to FIG. 10, FIG. 10 illustrates a second embodiment of the electrical connection device of the present disclosure, similarly, two busbar assemblies 10, 10′ are electrically connected with the third busbar 21 and the fourth busbar 22 of the mating busbar assembly 2 and the circuit boards 4 respectively via the plurality of first plugs 31 and the plurality of second plugs 32.

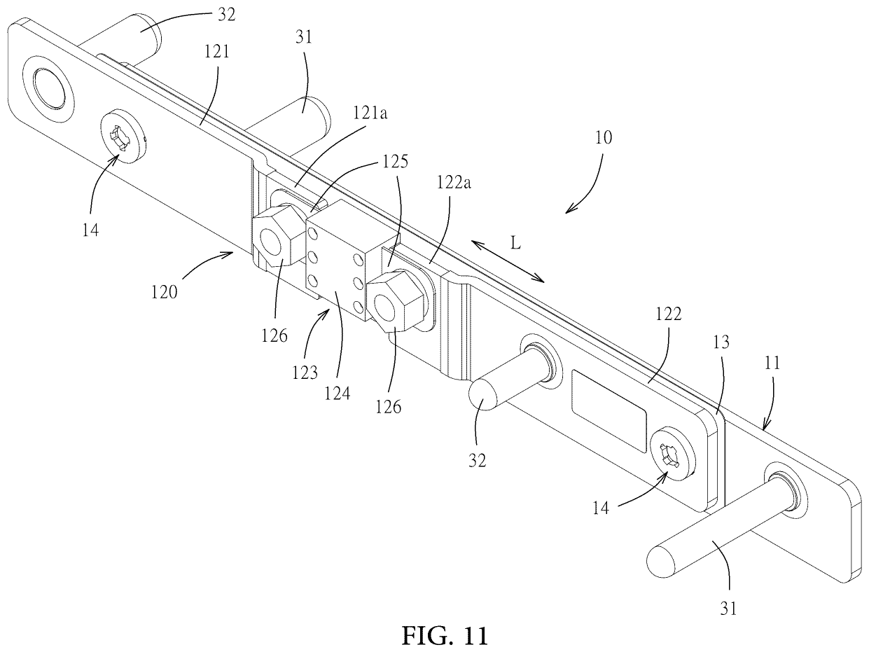

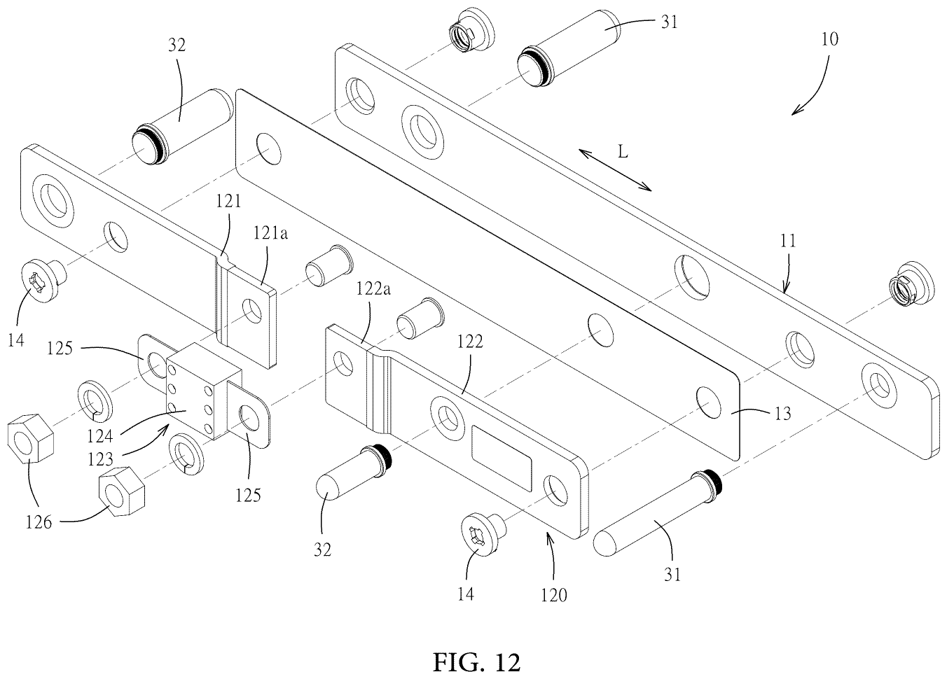

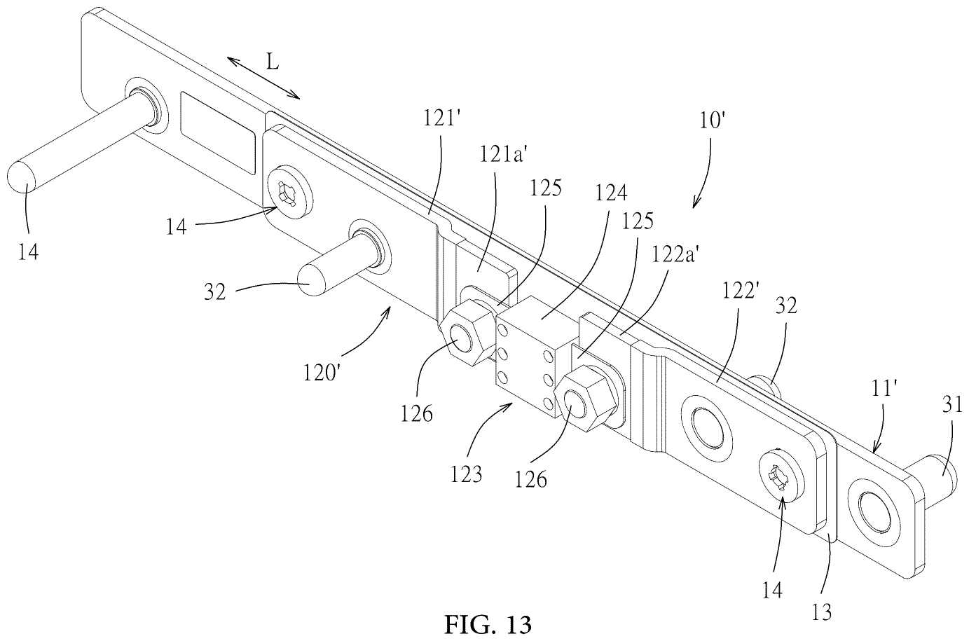

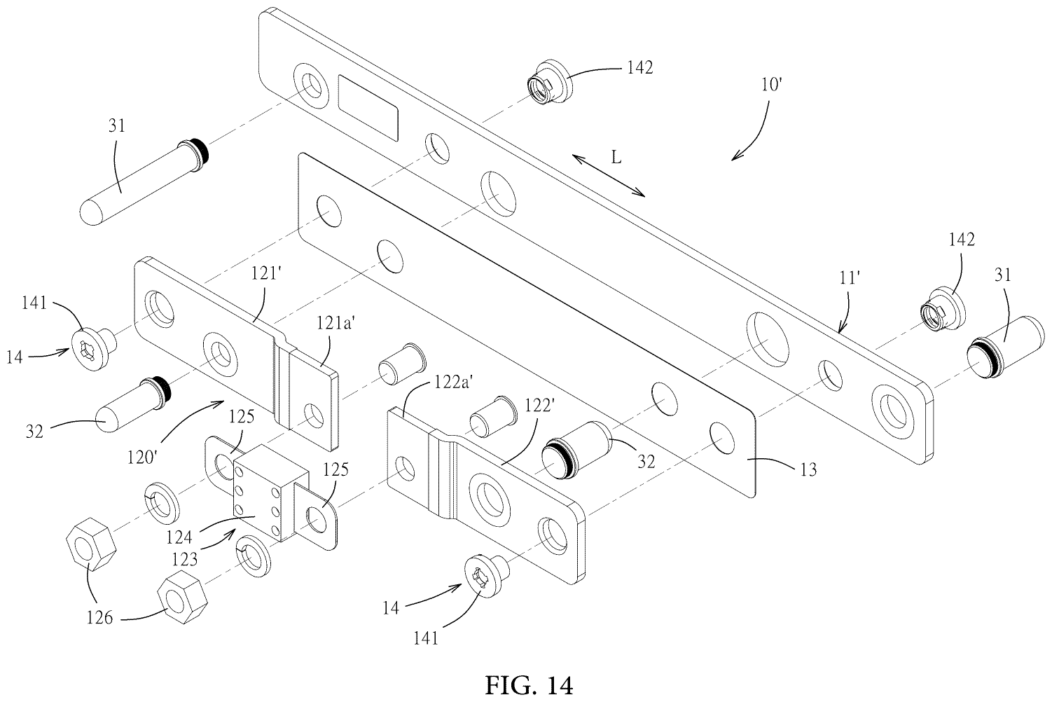

Referring to FIG. 11 to FIG. 14, the second embodiment differs from the first embodiment in that, in the first embodiment, the second busbar 12, 12′ of each busbar assembly 1, 1′is in form of single plate, but in the second embodiment, each second busbar 120, 120′ includes a first plate 121, 121′ and a second plate 122, 122′ which are spaced apart from each other and a fuse assembly 123 which is provided between the first plate 121, 121′ and the second plate 122, 122′, and the second busbar 120, 120′ acts as a live wire path. The two second plugs 32 are spaced apart from each other along the length direction L of each second busbar 120, 120′, are provided to the first plate 121, 121′ and the second plate 122, 122′ of each second busbar 120, 120′ respectively, and are respectively toward opposite directions. The locking assemblies 14 each include a screw 141 and a nut 142 which are used to lock each other, and the locking assemblies 14 fix the first plate 121, 121′ and the second plate 122, 122 together with the insulative layer 13 to the first busbar 11, 11′.

The fuse assembly 123 includes a fuse body 124 and two locking pieces 125 which protrude from two sides of the fuse body 124 respectively, in the second busbar 120, the two locking pieces 125 are respectively locked to ends 121a, 122a of the first plate 121 and the second plate 122 which face each other by screws 126, in the second busbar 120′, the two locking pieces 125 are respectively locked to ends 121a′, 122a′ of the first plate 121′ and the second plate 122′ which face each other via screws 126, and taking the second busbar 120 as example, cooperating with locking the fuse assembly 123, the ends 121a, 122a of the first plate 121 and the second plate 122 of the second busbar 120 which face each other bend, and when the first plate 121 and the second plate 122 are locked to the first busbar 11, the ends 121a, 122a of the first plate 121 and the second plate 122 which face each other are spaced apart from the first busbar 11, similarly, the ends 121a′, 122a′ of the first plate 121′ and the second plate 122′ of the second busbar 120′ which face each other bend, and when the first plate 121 and the second plate 122 are locked to the first busbar 11, the ends 121a′, 122a′ of the first plate 121′ and the second plate 122′ which face each other are spaced apart from the first busbar 11′. Moreover, in the second embodiment, except the ends 121a, 122a, 121a′, 122a′ of the first plate 121, 121′ and the second plate 122, 122′ of each second busbar 120, 120′ which face each other, other locations also may be coated with an insulative layer.

In the second embodiment, by that the fuse assembly 123 is provided to the busbar assembly 1, 1′ of the second busbar 120, 120′, in addition to that a space of the circuit board for providing the fuse assembly 123 may be saved, when a current flows to the circuit board is too large, due to blocking from the fuse assembly 123, it also may avoid too large current damaging electronic components of the circuit board.

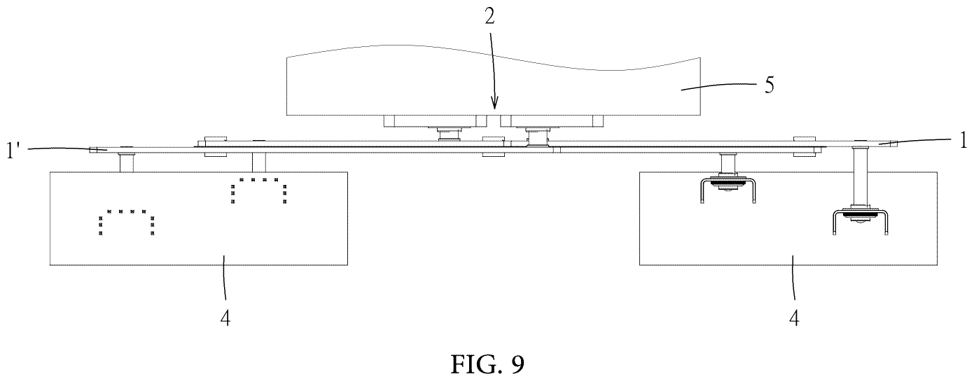

Referring to FIG. 1, FIG. 2 and FIG. 9, as described above, in the present disclosure, by employing the plurality of first plugs 31 opposite in direction and the plurality of the second plug 32 opposite in direction, a structure that the busbar assembly 1, 1′is electrically connected with the mating busbar assembly 2 and the circuit board 4 respectively is simplified. Moreover, by that busbar assembly 1, 1′is provided as a flat-plate shaped structure, and in cooperation with provision of the mating busbar assembly 2, the first plugs 31 and the second plugs 32 and the first receptacles 33 and the second receptacle 34, when the mating busbar assembly 2 needs to be electrically connected with the circuit board 4 via the busbar assembly 1, 1′, a distance between the mating busbar assembly 2 and the circuit board 4 may be shorten, in turn a space that the entire system needs to occupy is reduced, so the object of the present disclosure can be indeed realized.

Moreover, in the second embodiment, by that the fuse assembly 123 is provided to the second busbar 120, 120′ of the busbar assembly 1, 1′, in addition to that a space of the circuit board for providing the fuse assembly 123 may be saved, it also may avoid too large current damaging the electronic components of the circuit board.

However, the above description is only for the embodiments of the present disclosure, and it is not intended to limit the implementing scope of the present disclosure, and the simple equivalent changes and modifications made according to the claims and the contents of the specification are still included in the scope of the present disclosure.

What is claimed is:

1. An electrical connection device, comprising:
a busbar assembly comprising a first busbar and a second busbar which are insulated from each other; and
a connecting assembly comprising:
two first plugs which are spaced apart from each other along a length direction of the first busbar, are provided to the first busbar, and are respectively toward opposite directions; and
two second plugs which are spaced apart from each other along a length direction of the second busbar, are provided to the second busbar, and are respectively toward opposite directions.

2. The electrical connection device of claim 1, wherein
the first busbar and the second busbar overlap with each other, and two ends of the first busbar respectively extend beyond two ends of the second busbar.

3. The electrical connection device of claim 1, wherein
the first busbar and the second busbar overlap with each other, and one end of any one of the first busbar and the second busbar extends beyond one end of the other of the first busbar and the second busbar.

4. The electrical connection device of claim 1, wherein
the second busbar comprises a first plate and a second plate which are spaced apart from each other and a fuse assembly which is provided between the first plate and the second plate.

5. The electrical connection device of claim 4, wherein
an end portion of the first plate and an end portion of the second plate are spaced apart from each other and face each other,
the fuse assembly comprises a fuse body and two locking pieces which protrude from two sides of the fuse body, the two locking pieces are respectively locked to the end portions of the first plate and the second plate which face each other.

6. The electrical connection device of claim 5, wherein
the end portions of the first plate and the second plate which face each other bend to be spaced apart from the first busbar.

7. The electrical connection device of claim 2, wherein
one of the two second plugs which are provided to the second busbar passes through the first busbar.

8. The electrical connection device of claim 7, wherein
the first busbar is provided with a through hole which allows the one of the two second plugs to pass through, and a diameter of the through hole is larger than the one of the two second plugs so that the one of the two second plugs does not contact the first busbar when the one of the two second plugs passes through the through hole.

9. The electrical connection device of claim 8, wherein
an inner edge of the through hole is provided with an insulative layer which prevents the one of the two second plugs from contacting and being electrically connected with the first busbar.

10. The electrical connection device of claim 1, wherein
the first busbar and the second busbar are provided therebetween with an insulative layer to be insulated from each other.

11. The electrical connection device of claim 1, wherein
the electrical connection device further comprises a mating busbar assembly, the mating busbar assembly comprises a third busbar and a fourth busbar, and
the connecting assembly further comprises a plurality of first receptacles which are provided to the third busbar and the fourth busbar, the plurality of first receptacles allow some of the two first plugs and the two second plug to mate therewith in a pluggable and floatable manner so that the busbar assembly and the mating busbar assembly are electrically connected with each other.

12. The electrical connection device of claim 11, wherein
when the busbar assembly and the mating busbar assembly are electrically connected with each other, a length direction of the busbar assembly and a length direction of the mating busbar assembly have an angle therebetween.

13. The electrical connection device of claim 12, wherein
the busbar assembly is provided in a transverse direction, the mating busbar assembly is provided in a longitudinal direction.

14. The electrical connection device of claim 11, wherein
the third busbar and the fourth busbar are flat-plate shaped and are provided to be arranged side by side with a plate edge of the third busbar and a plate edge of the fourth busbar facing each other.

15. The electrical connection device of claim 1, wherein
the electrical connection device further comprises a circuit board which is provided in a horizontal direction, and
the connecting assembly further comprises a plurality of second receptacles which are provided to the circuit board, the plurality of second receptacles respectively allow some of the two first plugs and the two second plugs to mate therewith in a pluggable and floatable manner so that the busbar assembly and the circuit board are electrically connected with each other.

16. The electrical connection device of claim 15, wherein
the circuit board comprises a board body and conductive seats which are provided to the board body, the conductive seats are uprightly provided relative to the board body, the plurality of second receptacles are provided to the conductive seats, respectively.

17. The electrical connection device of claim 1, wherein
the first busbar and the second busbar are flat-plate shaped.

18. The electrical connection device of claim 1, wherein
each first plug has a mounting portion which is provided to the first busbar and a contact portion which protrudes from the mounting portion and is in form of post, the contact portions of the two first plugs are toward the opposite directions respectively;
each second plug has a mounting portion which is provided to the second busbar and a contact portion which protrudes from the mounting portion and is in form of post, the contact portions of the two second plugs are toward the opposite directions, respectively.

19. The electrical connection device of claim 1, wherein
the electrical connection device further comprises:
a mating busbar assembly which comprises a third busbar and a fourth busbar, and the connecting assembly further comprises a plurality of first receptacles which are provided to the third busbar and the fourth busbar, the plurality of first receptacles allow some of the two first plugs and the two second plug to mate therewith in a pluggable and floatable manner so that the busbar assembly and the mating busbar assembly are electrically connected with each other; and
a circuit board which is provided in a horizontal direction, and the connecting assembly further comprises a plurality of second receptacles which are provided to the circuit board, the plurality of first receptacles and the plurality of second receptacles respectively allow the two first plugs, which are respectively toward the opposite directions, and the two second plugs, which are respectively toward the opposite directions, to mate therewith in a pluggable and floatable manner so that the mating busbar assembly and the circuit board are electrically connected with each other via the busbar assembly.

20. The electrical connection device of claim 19, wherein
when the two first plugs and the two second plugs mate with the plurality of first receptacles and the plurality of second receptacles, the two first plugs and the two second plugs are capable of floating relative to the plurality of first receptacles and the plurality of second receptacles along an inserting direction and a radial direction perpendicular to the inserting direction.

21. The electrical connection device of claim 20, wherein
the first receptacle and the second receptacle each comprise a base, a barrel-shaped member, a pressure applying member and a contacting member;
the base has a passageway which extends between two ends of the base and an annular receiving groove which extends outwardly from the passageway,
the barrel-shaped member has a barrel body whose outer diameter is less than the passageway and an annular flange which extends outwardly from an outer wall surface of the barrel body, the annular flange is movably received in the annular receiving groove,
the pressure applying member has elasticity and is provided between the annular flange of the barrel-shaped member and the annular receiving groove to allow the barrel-shaped member to be floatable in the passageway along the inserting direction,
the contacting member is provided in the barrel body of the barrel-shaped member;
the first plug and the second plug each have a contact portion, the contact portion inserts into the corresponding one of the first receptacle and the second receptacle along the inserting direction and contacts the contacting member, and is capable of floating relative to the contacting member along the radial direction.
